(19) United States
(12) Patent Application Publication
(10) Pub. No.: US 2015/0298048 A1
(43) Pub. Date: Oct. 22, 2015

(54) CARBON DIOXIDE ADSORPTION AND REGENERATION APPARATUS

(71) Applicant: KOREA RAILROAD RESEARCH INSTITUTE, Uiwang-si, Gyeonggi-do (KR)

(72) Inventors: Young Min CHO, Gyeonggi-do (KR); Soon Bark KWON, Gyeonggi-do (KR); Duck Shin PARK, Gyeonggi-do (KR); Woo Sung JUNG, Gyeonggi-do (KR)

(73) Assignee: KOREA RAILROAD RESEARCH INSTITUTE, Gyeonggi-do (KR)

(21) Appl. No.: 14/648,150

(22) PCT Filed: Dec. 3, 2013
(86) PCT No.: PCT/KR2013/011086

§ 371 Date: May 28, 2015

(30) Foreign Application Priority Data
Dec. 4, 2012 (KR) 10-2012-0139875

(51) Int. Cl. B01D 53/04

(52) U.S. Cl. CPC B01D 53/0454; B01D 53/0438; B01D 2257/504

(57) ABSTRACT

The present invention relates to a carbon dioxide adsorption and to a regeneration apparatus, and more particularly, to a carbon dioxide adsorption and to a regeneration apparatus which adsorb carbon by means of a carbon dioxide adsorption unit and allow the carbon dioxide to be separated from the adsorption unit so as to be reused by detecting if an adsorption state is saturated. To achieve the above mentioned purpose, the present invention includes: a case; the adsorption unit that is provided in the case so as to adsorb the carbon dioxide; and a control unit that controls the adsorption unit, wherein the adsorption unit has a hot wire than has a heating element, and an adsorption layer is coated with a carbon dioxide adsorbing agent outside the hot wire.

### TECHNICAL FIELD

The present invention relates to an carbon dioxide adsorption and regeneration apparatus, and in particular to an carbon dioxide adsorption and regeneration apparatus wherein a carbon dioxide adsorption unit adsorbs carbon dioxide, and if adsorption is saturated, the saturated state is detected, and carbon dioxide is separated from an adsorption unit and is reused.

### BACKGROUND ART

The typical technology for adsorbing carbon dioxide is configured to selectively isolate CO₂ through a repeating process of absorption and removing using an absorbent which is able to physically and chemically adhere with CO₂. The chemical absorption method is more available in case where the concentration of combustion and exhaust and CO₂ is low, and the physical absorption method is more advantageous for a facility which has a high concentration of CO₂. When it needs to remove the adsorbed carbon dioxide, high temperature and high pressure conditions are necessary, and energy consumption increased, and the degradation of the absorbent and the corrosion due to the absorbent occur.

Since the above method for adsorbing carbon dioxide has low energy consumption, and the absorbent can be retrieved and reused, such a method is regarded as an economical technology to adsorb and remove carbon dioxide. The absorbent is considered an important factor to determine the performance in processes, for which the development of a new absorbent with higher performance is very important. In particular, active carbon and zeolite are representative adsorption materials which are most used in the separation processes of carbon dioxide, of which the zeolite is crystal alumina silicate and has a single size of fine pores, thus providing good adsorption performance with respect to hydrophilic and polar molecules. However, since there is a big difference in the removing efficiency and duration time of carbon dioxide at room temperature and under normal pressure depending on the composition ratio of alumina and silicate and the sizes of samples, there is a problem in quantifying such operations, which still remains.

In order to resolve the above problem, as illustrated in FIG. 1, the Korean Patent Registration No. 10-0879312 discloses a technology. As for the technology, the method for preparing absorbent which adsorbs carbon dioxide at room temperature and under normal pressure includes a step wherein given the size of particles of carbon dioxide, Si/Al ratio is set to 1 to 1.5, and zeolite 13X having fine pores and channels with uniform sizes of diameters, a step wherein the zeolite 13X is put in an oven and is heated to 150° C. to 200° C. in order to stabilize the fine pores formed in the prepared zeolite 13X and a wide surface formed in the form of channels and for the sake of physical modification which is necessary for separating and removing impurities attached inside, and the temperature-increased state maintains for a predetermined time, thus discharging internal air to the outside, a step wherein the thusly prepared zeolite 13X is put in a batch apparatus which contains aqueous solution in which lithium hydroxide of 0.3% by weight to 40% by weight as compared with the weight of the zeolite 13X is melted, and the internal pressure is maintained at 6 kg/cm² to 8 kg/cm², and the temperature is maintained at 70° C. to 90° C., and the mixture is agitated at below 200 rpm, and the lithium hydroxide is impregnated in the zeolite 13X or a step wherein the thusly prepared zeolite 13X is put in the batch apparatus which is under normal pressure, and the zeolite 13X rotates at 70° C. to 90° C. and at under 200 rpm, and the aqueous solution of lithium hydroxide is sprayed with a sprayer, and the lithium hydroxide is impregnated in the zeolite 13X, and a step wherein when the aqueous solution of lithium hydroxide is impregnated in the zeolite 13X, the temperature is maintained at 90° C. to 120° C. so as to minimally prevent the impregnation from concentrating at a portion of the zeolite 13X or the blocking of the fine pores formed in the zeolite, and the mixture is put in the vacuum oven to which low pressure applies and is dried for 3 to 8 hours.

The technology disclosed in the Korean Patent Registration No. 10-0879312, however, is advantageous since it is possible to provide an absorbent of carbon dioxide wherein the duration time of removal can greatly increase while efficiently and quickly removing carbon dioxide in such a way to allow as many particles of carbon dioxide as possible to contact with the fine pores and channels formed in the inside of the sample of zeolite, however if the thusly prepared carbon dioxide absorbent adsorbs carbon dioxide and becomes saturated, it needs to exchange with a new carbon dioxide absorbent, which entails a lot of cost, and if the carbon dioxide absorbent is reused so as to reduce the cost, an additional process for removing carbon dioxide adsorbed in the absorbent may be necessary.

### DISCLOSURE OF THE INVENTION

The present invention is made in an effort to resolve the above-mentioned problems. Accordingly, it is an object of the present invention to provide a carbon dioxide adsorption and regeneration apparatus wherein an adsorption unit for adsorbing carbon dioxide is provided in the inside of a case which covers an outer configuration, and the adsorption unit includes a heating cable formed of a heating member, and an adsorption layer made by coating a carbon dioxide absorbent on the outer side of the heating cable, and if the carbon dioxide becomes saturated in the course of adsorption of carbon dioxide, the carbon dioxide adsorbed by the adsorption layer is separated and adsorbed by heating the heating cable, and the above operation can be performed without exchanging the adsorption unit.

It is another object of the present invention to provide an carbon dioxide adsorption and regeneration apparatus wherein a fan is provided at a front side of a case accommodating an adsorption for introducing external air into the inside, thus easily adsorbing carbon dioxide, and a first concentration sensor and a second concentration sensor are provided at a front side and a rear side of the case, thus detecting the state of the adsorption unit by comparing the concentrations of carbon dioxide. The heating cable can be heated at an appropriate time, thus efficiently separating carbon dioxide adsorbed on the adsorption unit, which may lead to stable operations of the system.

To achieve the above objects, there is provided an carbon dioxide adsorption and regeneration apparatus, which includes a case; an adsorption unit which is provided in the inside of the case so as to adsorb carbon dioxide; and a control unit which controls the adsorption unit.

Here, the adsorption unit includes a heating cable which is formed of a heating member; and an adsorption layer wherein a carbon dioxide absorbent is coated on an outer surface of the heating cable.

In addition, the control unit activates the heating cable at regular cycles that a user sets, thus removing carbon dioxide from the adsorption layer.

Meanwhile, a first concentration sensor and a second concentration sensor for detecting the concentrations of carbon dioxide are installed at a front side and a rear side of the case.

At this time, the control unit compares the concentrations of the carbon dioxide detected by the first concentration sensor and the second concentration sensor and allows to activate the heating cable if the difference between the concentrations of carbon dioxide is lower than the concentration difference that a user sets, thus separating carbon dioxide adsorbed on the adsorption layer.

In addition, a fan for sucking in external air is installed at a front side of the case.

### Advantageous Effects

According to the present invention, an adsorption unit for adsorbing carbon dioxide is provided in the inside of the case covering to the outer configuration. The adsorption unit is formed of a heating wire made of a heating element, and an adsorption layer the outer side of which is coated with a carbon dioxide absorbent. If carbon dioxide is saturated while adsorbing carbon dioxide, the heating wire is heated, and the carbon dioxide adsorbed on the adsorption layer is separated and absorbed, so that it can be reused without exchanging the adsorption unit.

In addition, according to another purpose of the present invention, a fan is provided at a front side of the case in which an adsorption unit is provided, so as to suck in external air into the inside, thus more easily adsorbing carbon dioxide, and a first concentration sensor and a second concentration sensor are provided at a front side and at a rear side of the case, thus comparing the concentrations of carbon dioxide and detecting the state of the adsorption unit, so the heating wire can be heated at adequate timing, by which the system can operate stably by separating the carbon dioxide adsorbed on the adsorption unit.

### BRIEF DESCRIPTION OF THE DRAWINGS

FIG. 1 is a flow chart illustrating a method for manufacturing a conventional carbon dioxide absorbent.

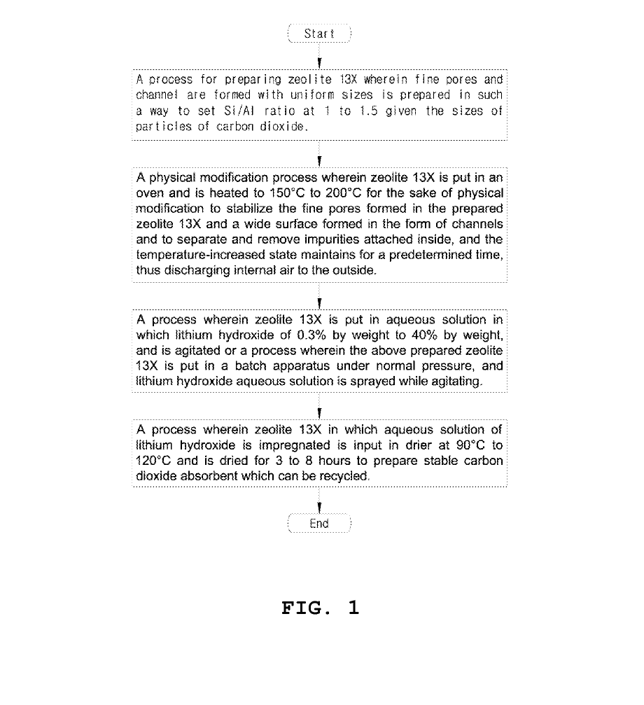

FIG. 2 is a concept view illustrating an carbon dioxide adsorption and regeneration apparatus according to the present invention.

FIG. 3 is a perspective view illustrating an adsorption unit of an carbon dioxide adsorption and regeneration apparatus according to the present invention.

FIG. 4 is a cross sectional view illustrating an adsorption unit of an carbon dioxide adsorption and regeneration apparatus according to the present invention.

FIG. 5 is a view for describing a state where an adsorption unit of an carbon dioxide adsorption and regeneration apparatus adsorbs carbon dioxide according to the present invention.

FIG. 6 is a view for describing a recycling process wherein carbon dioxide adsorbed on an adsorption unit of an carbon dioxide adsorption and regeneration apparatus according to the present invention.

FIG. 7 is a concept view illustrating an carbon dioxide adsorption and regeneration apparatus according to another exemplary embodiment of the present invention.

### MODES FOR CARRYING OUT THE INVENTION

The exemplary embodiments of the present invention will be described hereinafter with reference to the accompanying drawings. It is noted that the same reference numbers with respect to the same components will be used, and the duplicating descriptions on the same components will be omitted. In addition, it is obvious that the present invention may be implemented in different forms, and the present invention is not limited to the disclosed exemplary embodiments.

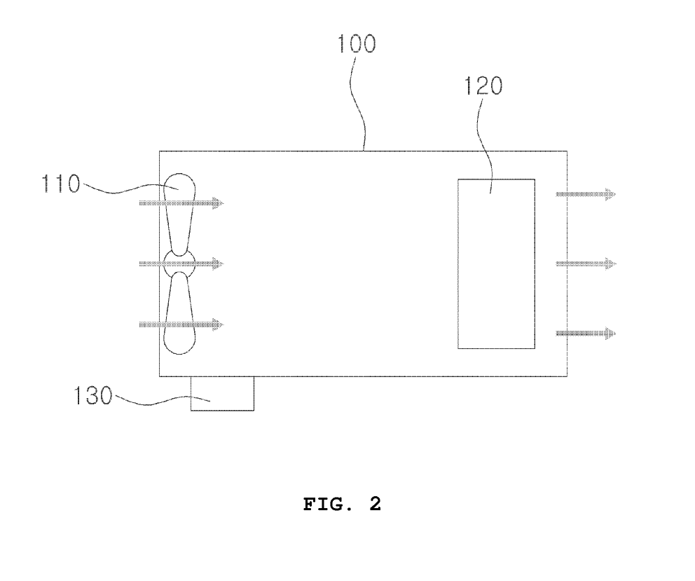

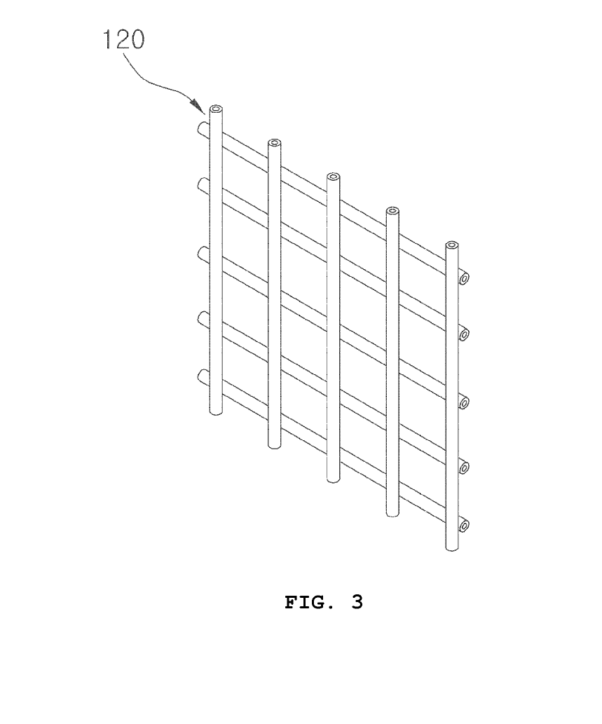

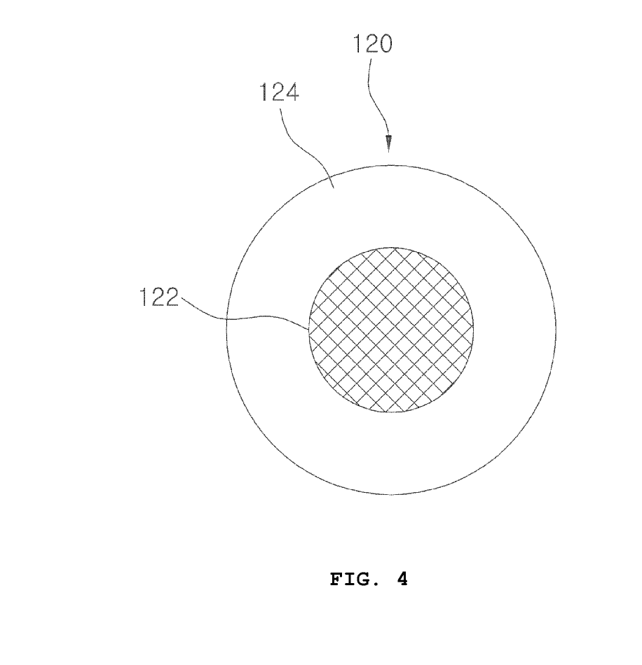

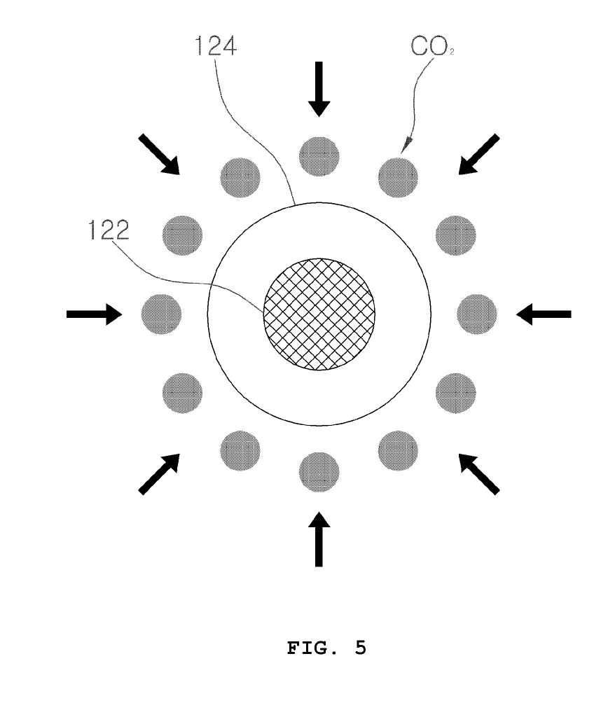

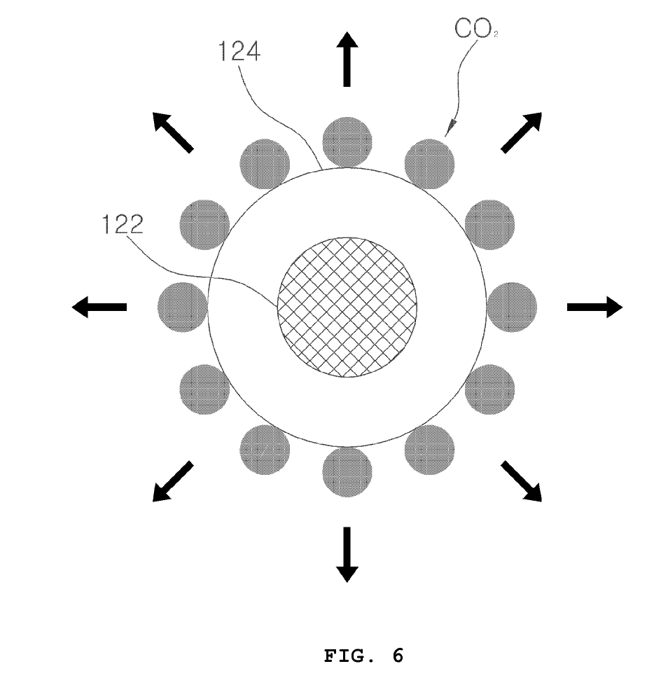

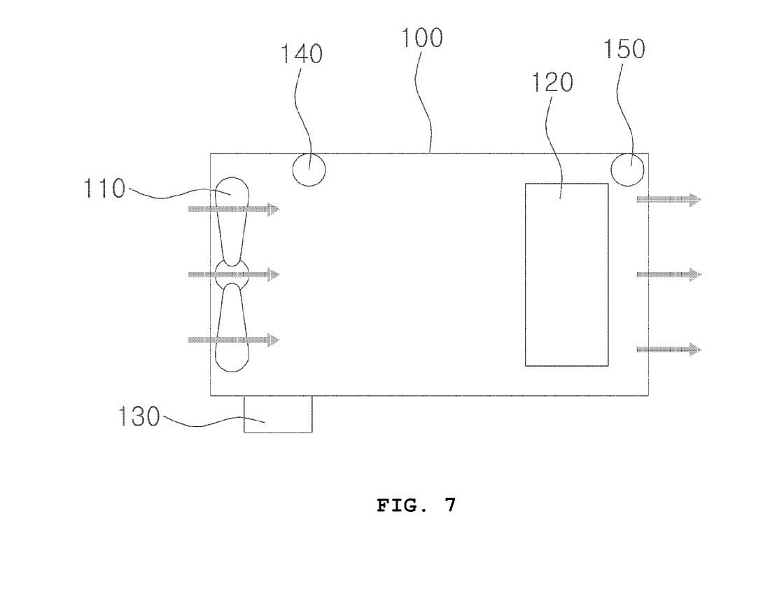

FIG. 2 is a concept view illustrating an carbon dioxide adsorption and regeneration apparatus according to the present invention, FIG. 3 is a perspective view illustrating an adsorption unit of an carbon dioxide adsorption and regeneration apparatus according to the present invention, FIG. 4 is a cross sectional view illustrating an adsorption unit of an carbon dioxide adsorption and regeneration apparatus according to the present invention, FIG. 5 is a view for describing a state where an adsorption unit of an carbon dioxide adsorption and regeneration apparatus adsorbs carbon dioxide according to the present invention, FIG. 6 is a view for describing a recycling process wherein carbon dioxide adsorbed on an adsorption unit of an carbon dioxide adsorption and regeneration apparatus according to the present invention, and FIG. 7 is a concept view illustrating an carbon dioxide adsorption and regeneration apparatus according to another exemplary embodiment of the present invention.

The present invention is directed to an carbon dioxide adsorption and regeneration apparatus which, as illustrated in FIGS. 2 to 4, includes a case 100 for covering an outer configuration, an adsorption unit 120 provided in the inside of the case 100, and a control unit 130 for controlling the adsorption unit 120.

Here, a fan 110 is further provided at a front side of the case 110. The fan 110 allows to suck in external air and supplies the air to the adsorption unit 120, thus enabling the adsorption unit 120 to easily adsorb carbon dioxide in the air.

Meanwhile, the adsorption unit 120 includes a heating cable 122 formed of a heating member which generates heat with the aid of electricity, and an adsorption layer 124 wherein an outer surface of the heating cable 122 is coated with a carbon dioxide absorbent.

At this time, the carbon dioxide absorbent is made of carbonate substances or silica, alumina, active carbon, zeolite, etc. thus stably adsorbing carbon dioxide. The heating cable 122 is made of a resistance substance, for example, a common nichrome cable, crystal, carbon, etc. When electricity applies in accordance with a control of the control unit 130, heat generates by the resistance.

Therefore, the fan 110 sucks in external air in accordance with a control of the control unit 130, and when the air contacts with the adsorption unit 120, as illustrated in FIG. 5, the adsorption layer 124 formed on the surface of the adsorption unit 120 adsorbs carbon dioxide in the air, and if the adsorption layer 124 adsorbs carbon dioxide and becomes saturated, the adsorption later 124 can no longer adsorb carbon dioxide. The control unit 130 supplies electricity to the heating cable 122, and the heating cable 122 is heated and supplies heat to the adsorption unit 124. As illustrated in FIG. 6, the carbon dioxide adsorbed by the adsorption layer 124 separates, so the adsorption layer 124 can adsorb carbon dioxide again.

Here, it is obvious that the heating cable 122 forming the adsorption unit 120 can be formed in various shapes, more preferably it may be formed in a mesh shape or a honey comb shape, so an appropriate shape can be used depending on the shape and installation position of the case 100.

In addition, the heating cable 122 can be heated to a temperature set by the control unit 130. The temperature set by the control unit 130 may be set to 50° C. to 250° C. depending on the kinds of the carbon dioxide absorbent, thus stably separating the carbon dioxide from the adsorption unit 124.

At this time, the control unit 130 allows to operate the heating cable 122 at regular cycles. The operating cycles may be set in consideration of the amount of carbon dioxide which is intended to be adsorbed, depending on the kinds and amount of the carbon oxide absorbent which forms the adsorption unit 124. The heating cable 122 is automatically controlled depending on the set cycle.

Meanwhile, as illustrated in FIG. 7, the apparatus for adsorbing and recycling carbon oxide according to another exemplary embodiment of the present invention may include a case 100 for covering an outer configuration, an adsorption unit 120 provided in the inside of the case 100, a fan 110 provided at a front side of the case 100, and a control unit 130 for controlling the adsorption unit 120 and the fan 110.

Here, a first concentration sensor 140 and a second concentration sensor 150 for detecting the concentration in the air are provided in the inside of the case 100. The first concentration sensor 14 is provided at a front side in the inside of the case 100, and the second concentration sensor 150 is provided at a rear side in the inside of the case 100.

Therefore, the concentrations of the carbon dioxide detected by the first and second concentration sensors 140 and 150 are transmitted to the electrically connected control unit 130, and the control unit 130 compares the concentration of the carbon dioxide of the inputted air detected by the first concentration sensor 140 with the concentration of the carbon dioxide of the discharged air detected by the second concentration sensor 150. If a difference between the concentrations is below a predetermined level, the control unit 130 supplies electricity to the heating cable 122 so as to activate the heating cable 122, thus heating the adsorption layer 124. The carbon dioxide adsorbed on the adsorption layer 124 separates from the adsorption layer 124 by the heat from the heating cable 122.

Namely, if a difference between the concentrations detected by the first concentration sensor 140 and the second concentration sensor 150 is above a predetermined level, since the adsorption unit 120 stably adsorbs carbon dioxide in the inputting air, the carbon dioxide in the discharging air decreases, thus resulting in high difference. In case where a difference between the concentrations is low, since the adsorption unit 120 cannot stably adsorb carbon dioxide in the inputted air, a lot of carbon dioxide still remains in the discharging air, which results in low difference. In case where the difference is below a predetermined level, the heating cable 122 is activated, and the carbon dioxide adsorbed on the adsorption layer 124 separates, so the adsorption layer 124 can normally adsorb the carbon dioxide.

Here, the difference of the adsorption concentration may be appropriately set depending on the situation at the place where the user installs.

In addition, the control unit 130 can set the difference of the concentrations of carbon dioxide to two levels. If the difference of the concentrations detected by the first concentration sensor 140 and the second concentration sensor 150 is lower than a first set level, such a situation may be determined as an emergency situation if the concentration is above a predetermined level depending on the level of the concentration from the first concentration sensor 140. In this case, the heating cable 122 is not activated, and the carbon dioxide should be continuously adsorbed, thus quickly removing the carbon dioxide in the air. If the concentration is lower than a predetermined level, which means that such a situation is not an emergency situation, the heating cable 122 is activated so as to separate the carbon dioxide adsorbed on the adsorption layer 124.

In addition, if the difference between the concentrations detected by the first concentration sensor 140 and the second concentration sensor 150 is lower than a second set level, which means that the adsorption capability of the adsorption layer 124 has significantly became lowered, the heating cable 122 is activated irrespective of the concentration of carbon dioxide in the inputted air, thus separating carbon dioxide from the adsorption layer 124, so the carbon dioxide can be normally adsorbed.

Meanwhile, the remaining components are same as the earlier described components, the detailed descriptions thereof will be omitted.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

### INDUSTRIAL APPLICABILITY

The present invention is directed to an carbon dioxide adsorption and regeneration apparatus wherein a carbon dioxide adsorption unit adsorbs carbon dioxide, and if adsorption is saturated, the saturated state is detected, and carbon dioxide is separated from an adsorption unit and is reused.

What is claimed is:

1. A carbon dioxide adsorption and regeneration apparatus, comprising:
a case;
an adsorption unit which is provided in the inside of the case so as to adsorb carbon dioxide; and
a control unit which controls the adsorption unit.

2. The apparatus of claim 1, wherein the adsorption unit includes:
a heating cable which is formed of a heating member; and
an adsorption layer wherein a carbon dioxide absorbent is coated on an outer surface of the heating cable.

3. The apparatus of claim 2, wherein the control unit activates the heating cable at regular cycles that a user sets, thus removing carbon dioxide from the adsorption layer.

4. The apparatus of claim 2, wherein a first concentration sensor and a second concentration sensor for detecting the concentrations of carbon dioxide are installed at a front side and a rear side of the case.

5. The apparatus of claim 4, wherein the control unit compares the concentrations of the carbon dioxide detected by the first concentration sensor and the second concentration sensor and allows to activate the heating cable if the difference between the concentrations of carbon dioxide is lower than the concentration difference that a user sets, thus separating carbon dioxide adsorbed on the adsorption layer.

6. The apparatus of claim 1, wherein a fan for sucking in external air is installed at a front side of the case.
